(19) United States
(12) Patent Application Publication
(10) Pub. No.: US 2008/0040560 A1
(43) Pub. Date: Feb. 14, 2008

(54) Lightweight Single Reader Locks

(76) Inventors: Charles Brian Hall, Calgary (CA); Zhong Liang Wang, Markham (CA)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/686,498

(22) Filed: Mar. 15, 2007

(30) Foreign Application Priority Data
Mar. 16, 2006 (CA) 2539908

(51) Int. Cl. G06F 12/14

(52) U.S. Cl. 711/152

(57) ABSTRACT

A method, system and computer program product for generating a read-only lock implementation from a read-only lock portion of program code. In response to determining that a lock portion of the program code is a read-only lock, a read-only lock implementation is generated to protect at least one piece of shared data. The read-only lock implementation comprises a plurality of instructions with dependencies created between the instructions to ensure that a lock corresponding to the data is determined to be free before permitting access to that data. In one embodiment, when executed, the read-only lock implementation loads a lock word from a memory address into a register and places a reserve on the memory address. The lock word is evaluated to determine if the lock is free, and, in response to determining that the lock is tree, at least one piece of shared data protected by the lock is accessed. A value is conditionally stored back to the memory address if the reserve is present. A dependency exists between the step of loading of the lock word and the step of accessing the at least one piece of shared data, thereby causing the step of loading of the lock word to be performed before the step of accessing of the at least one piece of shared data.

This invention is in the field of methods and systems to generate a read-only lock implementation of a lock on shared data and, more particularly, relates to a method and system for providing an improved read-only lock implementation.

### BACKGROUND

Multithreading of applications allows an operating system to run different parts (or threads) of a program simultaneously. Multiple threads can be run in parallel on most computer systems. The computer system typically achieves this multithreading by either time slicing, where a uniprocessor switches between different threads as it performs various instructions with the processor performing one or more instructions from one thread and then switching to another thread and performing one or more instructions from the other thread, or in multiprocessor systems running the threads on different processors.

These multiple threads, running simultaneously, typically share memory and other resources directly among the different threads. This means that shared data in a memory might be accessed by more than one of the running threads. This creates a problem when more than one thread tries to access the shared data at the same time because allowing two or more threads simultaneous access to a piece of shared data can cause a conflict between the threads. With two or more threads simultaneously accessing a piece of shared data, one thread may corrupt the shared data, by writing a new value to the shared data, while the other thread is trying to read the shared data.

This contention for shared data is typically addressed by the use of mutual exclusion of threads from the shared data. While a first thread is accessing the shared data, other threads are blocked from accessing the shared data until the first thread has finished. This is done with locks/monitors that are used to block additional threads from accessing the shared data until a first thread is finished accessing the data. Typically, while one thread has acquired a lock on a piece of shared data and is accessing that data, all other threads are prevented from obtaining a lock on the same data.

The typical sequence of operations to protect access to a piece of shared data consists of: 1) acquiring a lock protecting the piece of shared data; 2) accessing the piece of shared data with read or write operations; and 3) releasing the lock.

This sequence of operations is implemented using a variable containing a lock word which indicates whether or not the lock has been acquired by a thread. A thread wanting access to a piece of shared data protected by a lock, first checks the lock word to see if the piece of shared data is being accessed by another thread before attempting to access the shared data, if the value of the lock word indicates that the lock is free (i.e. no other threads are accessing the shared data), the thread will access the shared data after writing a new value in place of the previous lock word to indicate that the lock has now been acquired by a thread and the shared data is being accessed by a thread. Typically, such as in Tasuki lock implementations, a value of zero (0) for the lock word is used to indicate that the lock is tree and that no other threads are attempting to access the shared data. Typically, when a thread writes a value over the previous lock word to “lock” the shared data for that thread, the value is a thread identifier that identifies the thread that has acquired the lock. Once the thread has acquired the lock by writing a value over the previous lock word, the thread accesses the shared data. After the first thread has locked the shared data by writing a new value over the lock word, other threads attempting to access the shared data will first check the value of the new lock word and finding the lock word indicates the lock has been acquired by another thread, these other threads will not access the shared data.

By having the threads check a lock word to determine whether or not shared data is being accessed by another thread, the shared data is in effect locked when a thread is accessing the shared data and additional threads will not be able to access the shared data structure or resource until the first thread is done with the shared resource and the resource is “unlocked”

There are numerous methods in the prior art to implement a lock to protect shared data and handle additional threads trying to access the shared data. For example, thin bimodal locks are a widely adopted implementation for Java™ (Java and all Java based trademarks are trademarks of Sun Microsystems Inc. in the United States of America, other countries or both). One variant of these thin bimodal locks, known as “Tasuki” locks is described in a paper: “A Study of Locking Objects with Bimodal Fields” by Ondera and Kawachiya, OOPSLA '99 the Proceedings of ACM SIGPLAN Conference on Object-Oriented Programming Systems, Languages, and Applications, pp. 223-237, 1999.

These lock implementations all create processor overhead and take some time for the processor in order to implement the needed instructions. Locking overhead, i.e. monitor enter and exit-operations, have been a common source of performance problems for programs run in environments that require synchronization of multiple threads of execution using multithreading, such as Java programs. There has been a large amount of research into reducing locking overhead. There are two basic techniques to reduce locking overhead: 1) compiler techniques, and 2) runtime techniques. Compiler techniques eliminate locking operations through compiler analysis and transformation such as lock coarsening. Runtime techniques include compiler analysis and implementation to reduce the cost of locking operations.

Existing techniques to reduce locking overhead have been quite effective, but the performance problems have not been eliminated. Modern systems use any and all available compiler or runtime techniques in combination. There is always room for additional techniques that can be used when the existing techniques cannot be applied or the new techniques offer better performance in specific cases.

These conventional locking implementations require the use of memory barrier and atomic conditional update instructions in order for these lock implementations to run properly and these memory barrier and atomic conditional update instructions are generally the most expensive part, from an overhead point of view, of a locking procedure.

Many modern processors, including the Pentium 4 (“Pentium” is a trademark of the Intel Corporation) and all RISC; processors such as the PowerPC (“PowerPC” is a trademark of International Business Machines Corporation) range of processors, can perform instructions out-of-order. Rather than implementing instructions sequentially in the order that they occur in, these processor use pipelining in order to increase the speed of the processor. These processors can perform instructions out-of-order so that the processor can perform instructions occurring further ahead in the code while it is waiting during another instruction. These processors can, in essence, look ahead in the code to perform subsequent instructions during waiting periods.

By default, most modern processors that allow out-of-order instructions observe instruction dependency wherein ordering guarantees are provided for instructions that are dependent on previous instructions. For example, if an instruction is dependent upon the result returned in a preceding load instruction, i.e. add a value in the register to another value, where the value in the register was loaded into the register by a previous instruction, the processor enforces this instruction order and performs the load instruction before the addition instruction. However, in the absence of apparent dependencies between instructions, these processors can perform the instructions in various orders, with the result that the order the instructions are provided in the code not necessarily being the order in which these instructions are performed by the processor.

Synchronization instructions are used to prevent instructions from being performed out-of-order by a processor. Synchronization instructions create memory barriers that order the execution of the instructions making up the critical section. The memory barrier divides the instructions into pre-memory barrier instructions and post-memory barrier instructions. This means the processor will not perform post-memory barrier instructions until all of the pre-memory barrier instructions have been performed.

Conventional locking procedures use synchronization instructions for a number of reasons. Synchronization instructions in these implementations are used to prevent a thread from jumping ahead and reading or writing to a piece of shared data before the thread has determined the lock on the shared data is free. Locking procedures require accessing at least two separate variables: first, some sort of lock variable is required that is read to determine whether or not a lock is free; and secondly, a second variable that is a piece of shared data protected by the lock and separate from the lock variable is also required. Even more variables are needed if the lock protects more than one piece of shared data. To the processor implementing a lock sequence, it is not apparent to the processor that the lock variable and the at least one piece of shared data are dependent upon each other, so absent some sort of synchronization instruction, a processor might run the sequence out-of-order with the result that the piece of shared data is accessed by a thread before the thread determines from the lock variable whether or not the lock is in fact free.

Synchronization instructions are also used in these locking implementations to prevent other threads from accessing the piece of shared data protected by the lock. Because locking procedures allow a thread to access shared data, the lock acquisition requires atomic operations in order to prevent this shared data from being simultaneously accessed while it is being accessed by a first thread, otherwise instructions from another thread might be performed by a processor out-of-order with the result that even though a locking sequence being run by a thread is run in order, an instruction from another thread might be performed in the midst of another thread's locking sequence with the result that the shared data is altered by the other thread while the first thread is trying to access it.

Sometimes the synchronization instructions are used as a barrier to ensure the effects of previous Instructions are visible to other processors before continuing execution on this processor. For example, the “sync” instruction on PowerPC prevents the execution of the following instructions until previous stores have been completed and their effects are visible to other processors.

Finally, these locking implementations also require some synchronization to ensure that upon exiting the lock writes to free the lock are done in order to prevent the lock being freed before the shared data is accessed

Synchronization instructions are expensive because they can greatly impact the performance of a processor by preventing the processors from executing instructions, often for many machine cycles. Even on multiprocessor systems synchronization can slow down every processor in the system. Generally, these synchronization instructions are the most expensive part of a locking implementation.

### SUMMARY OF THE INVENTION

In one aspect, the present invention is directed toward a method of generating a read-only lock implementation from a read-only lock portion of a program code. The method comprises, in response to determining that a lock portion of a program code is a read-only lock, generating a read-only lock implementation to protect at least one piece of shared data wherein the read-only lock implementation comprises a plurality of instructions with dependencies created between the instructions to ensure that a lock, corresponding to the at least one piece of shared data is determined to be free before permitting access to the at least one piece of shared data.

In another aspect, the present invention is directed to a read-only lock implementation which, when executed by a data processing system, causes the data processing system to perform the following steps: loading a lock word from a memory address into a register and placing a reserve on the memory address; in response to loading the lock word, evaluating the lock word to determine if the lock is free; in response to determining that the lock is free, accessing at least one piece of shared data protected by the lock; and conditionally storing a value back to the memory address if the reserve is present. A dependency exists between the step of loading of the lock word and the step of accessing the at least one piece of shared data, thereby causing the step of loading of the lock word to be performed before the step of accessing of the at least one piece of shared data.

The invention further provides a multi-threaded data processing system for implementing the above methods and a computer program product comprising a computer useable medium including a computer-readable program for implementing the above methods.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic illustration of a data processing system suitable for supporting the operations of methods in accordance with aspects of the present invention;

FIG. 2 is a flowchart of a prior art method for acquiring a flat lock, reading a piece of shared data and releasing a tree flat lock;

FIG. 3 is a flowchart of a first embodiment of a method that is an implementation of a read-only flat lock to grant a thread access to a piece of shared data in accordance with an aspect of the present invention;

FIG. 4 is a flowchart of a second embodiment of a method that is an implementation of a read-only fiat lock to grant a thread access to a piece of shared data in accordance with an aspect of the present invention;

FIG. 5 is a flowchart of a method of a third embodiment that is an implementation of a read-only flat lock to grant a thread access to a first and second piece of shared data in accordance with an aspect of the present invention; and

FIG. 6 is a flowchart of a method of generating a read-only lock implementation from a read-only lock portion of a program code, in accordance with an aspect of the present invention.

### DETAILED DESCRIPTION OF THE ILLUSTRATED EMBODIMENTS

The present invention provides a runtime technique to reduce the cost of a read-only lock on computer architectures that have support for atomic memory update that consists of separate load-and-reserve (or load-and-link) and store-conditional machine instructions such as Alpha, MIPS and PowerPC.

The invention can take the form of an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. As used herein, the term “data processing system” is intended to have a broad meaning, and may include personal computers, laptop computers, palmtop computers, handheld computers, network computers, servers, mainframes, workstations, cellular telephones and similar wireless devices, personal digital assistants and other electronic devices on which computer software may be installed.

Input/output or 170 devices (including but not limited to keyboards, displays, pointing devices, etc.) can be coupled to the system either directly or through intervening I/O controllers.

Network adapters may also be coupled to the system to enable the data, processing system to become coupled to other data processing systems or remote printers or storage devices through intervening private or public networks. Modems, cable modems and Ethernet cards are just a few of the currently available types of network adapters.

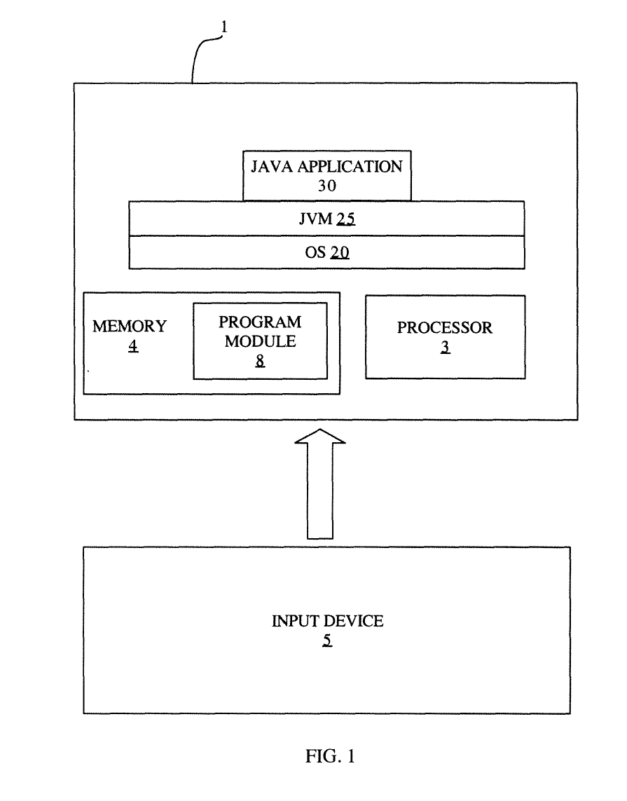

FIG. 1 illustrates a data processing system 1 suitable for supporting the operation of methods in accordance with the present invention. The data processing system 1 comprises: a processor 3; a memory 4; an input device 5; and a program module 8.

The processor 3 can be any processor that is typically known in the art with the capacity to run the program and is operatively coupled to the memory 4. The memory 4 is operative to store data and can be any storage device that is known in the art, such as a local hard-disk, etc. The input device 5 can be any suitable device suitable for inputting data into the data processing system 1, such as a keyboard, mouse or data port such as a network connection and is operatively coupled to the processor 3 and operative to allow the processor 3 to receive information from the Input device 5. The program module 8 is stored in the memory 4 and is operative to provide instructions to the processor 3 and the processor 3 is responsive to the instructions from the program module 8.

In an embodiment of the invention, a lava application 30 calls for a lock on a piece of shared data. Conventional computer system 1 has an operating system 20 on top of which runs a Java virtual machine 25. The Java virtual machine 25 operates as a virtual operating system and the Java application 30 is supported running on the Java virtual machine 25. Java bytecode is passed to the Java virtual machine 25 and the Java virtual machine 25 generates a corresponding implementation of the lock in a lower level code.

Although other internal components of the data processing system 1 are not illustrated, it will be understood by those of ordinary skill in the art that only the components of the data processing system 1 necessary for an understanding of the present invention are illustrated and that many more components and interconnections between them are well known and can be used.

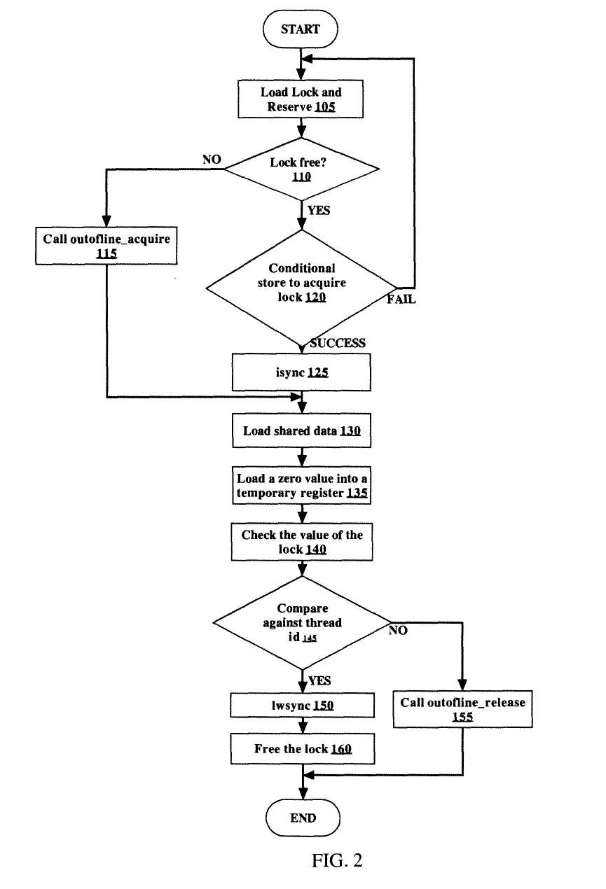

FIG. 2 illustrates a flow chart of prior art assembly code for implementing a conventional read-write flat lock where a piece of shared data is protected by the lock. This is a prior art implementation of a locking instruction sequence in assembler code to acquire a single reader fiat lock, read a single shared data item and release the lock. The method is similar to the sample code found in IBM Corporation, The PowerPC Architecture: A Specification for a New Family of MSC Processors, Second Edition, Morgan Kaufmann, 1994 with extensions to handle the recursive locking and other requirements of the Java language. However, the illustrated method may vary somewhat, such as the specific instructions used, depending on the specific computer architecture being used.

In the method a first register is used to hold the value of a lock word that indicates whether a lock has been acquired for the piece of shared data, a second register is used to store the address of the piece of shared data that is accessed by the method and a third register is used to store the piece of shared data when it is accessed by the method. It is to be understood for the purposes of the examples that the terms “first”, “second” and “third” are used in reference to the registers merely to distinguish between different registers and do not necessarily refer to the first, second and third available registers. A person skilled in the art will appreciate that various available registers in accordance with the particular computer architecture that is being used could be used to implement the following method.

The steps of the method comprise: loading a lock word and reserving the memory location the lock word was loaded from 105; testing to see if the lock is free 110; calling outofline_aquire if the lock is not free 115; conditionally storing a value to the lock word to acquire the lock 120 if the lock is free; a synchronization instruction 125; loading a piece of shared data 130; loading a zero value 135; checking the lock word 140; comparing the lock word against a thread id 145; another synchronization instruction 150; calling outofline_release 155; and freeing the lock 160 before ending.

Steps 105, 110, 115 and 120 acquire a lock on a piece of shared data. The method begins at step 110 with the lock being loaded into a first register and a reserve placed on the location in memory that the lock word was loaded from. The load and reserve at step 105 works in conjunction with a store conditional instruction at step 120. The reserve is set in the processor and if the address the lock was stored in is updated by another thread the processor will detect this update of the data at the address and clear the reservation. At step 120 with the store conditional command, if the reserve is not still present, the store instruction fails. The load and reserve at step 105 is part of the atomic memory update sequence.

After the lock word is loaded into a first register at step 105, step 110 tests the lock word to determine whether the lock is free or whether the lock has been acquired by another thread. If the lock implementation uses a zero (0) value of the lock word to indicate a free flat lock, such as in a Tasuki lock implementation (although other types of lock implementation could also be used), a value of zero (0) for the lock word indicates that the lock is free and a non-zero value of the lock word indicates that the lock has been acquired by another thread. If the lock is free the method can continue on and acquire the lock and access the piece of shared data. However, should the lock not be tree (i.e. the lock word contains a non-zero value), a call to outofline_acquire is invoked 115.

The outofline_acquire 115 handles the case where the shared data is locked. It can handle a recursive lock enter if the thread has already acquired the lock, dealing with contention if another thread currently holds the lock or handling an inflated lock. The call at step 115 calls out of line code that handles the infrequent cases where the lock is not free. This out of line code checks for a recursive acquire of a flat lock and in that case all that is necessary is to increment the count part of the flat lock (the one special case is an overflow of the count field, forcing inflation of the lock).

If the lock is identified as free at step 110, the thread attempts to acquire the lock by writing a value to the lock word in memory at step 120. For a Tasuki lock implementation a lock is acquired by writing a non-zero value into the lock, word, where the value is some type of thread identifier indicating the owning thread and part of the lock word (separate from the thread identifier) is used as a counter to implement recursive locking (with a count of zero (0) indicating that the lock is locked but not recursively locked). A conditional store instruction is used at step 120 and a new value for the lock word will only be stored in the location in the memory storing the lock word if the reserve from step 105 is still present. At step 110, if the reserve is not present, indicating that the lock word in memory has been updated since the lock word was loaded into a first register at step 105 and therefore likely not free, the store at step 120 will fail and the method loops back and tries to acquire the lock again starting with step 105. If at step 120, the reserve is still present, the lock word stored in memory has not been updated and the store will be successful.

If the store at step 120 is successful, the lock word stored in memory indicates to the other threads that the shared data has been locked by this thread and the method proceeds to step 125 Step 125 is an instruction to synchronize the execution of instructions. For a PowerPC computer architecture the instruction used is an isync instruction, however, other computer architectures might use different but substantially corresponding instructions to achieve a similar result. The synchronization at step 125 is a memory barrier which causes all the instructions indicated previous to the synchronization step 125 to be performed. Because a processor can perform instructions out of order, without this synchronization instruction at step 125, later steps might be performed before earlier steps. For example, without the synchronization at step 125 a processor implementing the method might perform step 130 before step 110. Step 125 prevents execution of the steps following step 125 before ail the previous steps have been completed. In this implementation of the lock, step 125 is required to ensure that any accesses to the shared data are not yet started. This synchronization step is a major cause of overhead in the implementation of tins lock.

Step 130 loads the piece of shared data into a second register and is the portion of the method where the piece of shared data is accessed by the thread. This is the step where the shared data is actually read.

Finally, steps 135, 140, 145, 150, 155 and 160 comprise the portion of the method where the lock is released.

Step 135 loads a zero (0) value into a third register.

Step 140 loads the lock word into the first register and step 145 compares the value of the lock word against the thread identifier of the thread to determine whether the lock has been acquired by the present thread.

Step 150 is another synchronization step. Step 150 is required to guarantee previous load or store operations to the piece of shared data are completed before the method continues. Using a PowerPC computer architecture, the synchronization instruction used is 1 wsync (however, corresponding instructions may be used for different computer architectures) which controls the ordering of storage accesses to system memory only and while it does not require as much processor overhead as other synchronization instructions, such as isync, it still increases processor overhead.

Step 155 calls an outofline_release. This out of line code handles infrequent cases, returning to the label outofline_release_return. The out of line code first checks for a recursive release of a flat lock, and in that case all that is necessary is to decrement the count part of the flat lock.

Step 160 frees the lock, allowing other threads to acquire the lock and gain access to the piece of shared data. The lock is freed by writing a value to the lock word in memory indicating that the lock is free, if the lock is implemented as a Tasuki lock implementation, a zero value (0) is written into the location of the memory where the lock word is stored.

After the lock is freed at step 160 the method ends.

An example of assembler code of a sample PowerPC instruction sequence for the method illustrated in FIG. 2 is set out in the Example below.

| Assembler code | Comments |
|---|---|
| loop: | |
| lwarx r5,0,r3 | load and reserve (read part of atomic |
| | update) |
| cmpwi r5,0 | test for a free flat lock |
| bne outofline_acquire | out-of-line code handles recursive acquire |
| | contention, or inflated |
| stwcx. r4,0,r3 | store conditional(write part of atomic |
| | update) |
| bne- loop | try again if conditional write failed |
| isync | EnterLoad barrier (prevent out-of-order |
| | execution of following code) |
| outofline_aquire_return: | return here from the out-of-line acquire |
| | code |
| lwz r31,104(r8) | lock protects just this shared data load |
| li r0,0 | monitor exit sequence in blue |
| lwz r5,0(r3) | check the value of the lock |
| cmpw r5,r4 | compare against thread id |
| bne outofline_release | out-of-line code handles recursive release |
| | or inflated |
| lwsync | StoreExit barrier (ensure previous shared |
| | data load/store operations complete before |
| | continuing) (for Java this must include |
| | shared data stores before the monitor enter) |
| stw r0,0(r3) | free the lock by writing a 0 value |
| outofline_release_return: | return here from outofline release code |

The conventional lock implementation illustrated by the flowchart in FIG. 2 requires a number of synchronization operations to ensure the correct operation of the lock. First some type of atomic memory update sequence is used to read the value of a lock word and ensure that the lock is currently free. If the lock is free, the write part of the atomic operation acquires the lock for the thread by writing a thread id to the lock word. Following the successful write to the lock word, a further synchronization operation is required to ensure that any accesses to the shared data have not yet started.

The lock exit operation again requires some synchronization. Synchronization must be used to guarantee that all read or write operations on the piece of shared data have been completed before the lock is treed by writing a new value to the lock word.

Dynamically, a large majority of locking operations are to acquire a tree flat lock or to release a flat lock with a zero count. A much less frequent locking operation is to recursively acquire or release a flat lock. Quite infrequently there is an attempt to acquire a lock owned by another thread (a contended case), or to have an inflated lock. If the piece of shared data is only accessed through read operations, the implementation of a flat lock can be improved by simplifying the instruction sequence and eliminating some memory barrier operations which are typically the most expensive parts of the conventional implementation illustrated in FIG. 2.

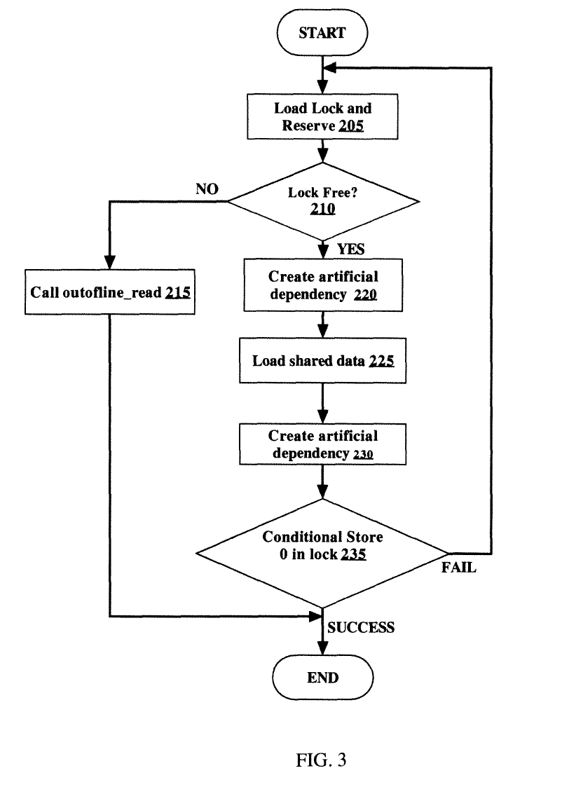

FIG. 3 illustrates a flowchart of a first embodiment of a method that is an implementation of a read-only flat lock to grant a thread access to a piece of shared data in accordance with the present invention. The method does not acquire and release the lock by writing to the lock word, but rather the method just guarantees that the lock is actually free while the piece of shared data is accessed. Rather than relying on a number of synchronization instructions that will result in substantial processor overhead costs, the method includes a number of steps that perform operations that do not affect the values of the data in the method, but create dependencies between the instructions so that a processor executing the instructions will see dependencies between the instructions and perform the instructions in a required order. Because these additional operations are not strictly necessary to alter the data but rather are merely used to get the processor to implement the steps of the method in the required order, the dependencies are in essence artificial dependencies.

In addition, because the lock is a read-only lock, and there is no modification of the piece of shared data, there is no need of some costly synchronization instructions that would be used to actually acquire and then later release the lock and thereby prevent the access to the shared data by other threads. Instead, a load word and reserve index instruction and a corresponding conditional store instruction are used to ensure that the piece of shared data has not been accessed by another thread while the method is being performed.

By not acquiring the lock, but rather simply checking to ensure the lock is free, some synchronization instructions can be avoided. However, even if synchronizations are used, by simply ensuring a lock is free before accessing one or more pieces of shared data rather than acquiring the lock before accessing the one or more pieces of shared data, a store instruction to save a value into the lock word stored in memory can be avoided. Because this avoidance of a store instruction alone provides some benefit in reducing processor overhead, it is contemplated that a lock could be implemented using synchronization instructions yet simply ensuring the lock is free without acquiring the lock in order to reduce the overhead of the lock by avoiding the use of a store instruction.

In the embodiment shown, a first register is used to hold the value of a lock word that indicates whether a lock has been acquired for the piece of shared data, a second register is used to store the address of the piece of shared data that is accessed by the method and a third register is used to hold the contents of the piece of shared data when it is accessed by the method. As noted above, it is to be understood for the purposes of this example that “first”, “second” and “third” are used in reference to the registers merely to distinguish between different registers for the purposes of explaining the method and do not necessarily refer to the first, second and third available registers of a computer architecture. A person skilled in the art will appreciate that various available registers In accordance with the particular computer architecture that is being used could be used to implement the following method.

The method comprises the steps of: loading a lock word from a location in memory and placing a reserve on the location in the memory 205; checking to determine whether the lock is free 210; calling an outofline_read 215 if the lock is not free; creating an artificial dependency 220 if the lock is free; loading a piece of shared data 225; creating another artificial dependency 230; and conditionally storing a value to the lock word in memory 235.

The method starts at step 205 with the lock word being loaded into the first register and a reserve placed on the memory location where the lock word was accessed from.

At Step 210, the lock word is evaluated to determine if the lock is free (i.e. that another thread has not locked the piece of shared data by writing to the location in the memory where the lock word is stored). If the lock word uses a zero (0) value to indicate that the lock is tree, at step 210 the value of the lock word is checked to see if it is zero (0).

If the lock is not free, step 215 calls an outofline_read method. If the lock is already held by this thread, the out of line code need only perform the load and does not need to modify the lock.

This outofline_read method also deals with the case where the lock is in contention or inflated by calling a monitor enter helper, doing the load and then calling a monitor exit helper.

An example of assembler code of a sample PowerPC instruction sequence for the outofline_read method at step 215 is set out in the Example below.

| Assembler code | Comments |
|---|---|
| outofline_read: | |
| rlwinm gr0,gr5,0,0,23 | get just thread value |
| cmpw r0,gr4 | test for this thread has lock |
| bne call_helpers | heavy-weight calls handle contention, |
| | or inflated |
| lwz r31,104(r8) | lock hel by this thread; just do the |
| | load |
| b outofline_read_return | |
| call_helpers: | |
| bl monitorenter_helper | call heavy-weight enter helper |
| lwz r31,104(r8) | do the load |
| bl monitorexit_helper | call heavy-weight exit helper |
| b outofline_read_return | |

However, if at step 210 the lock is found to be free, the piece of shared data can be accessed and the method moves on to step 220.

Rather than using a synchronization instruction at this point to enforce an ordering of the method steps by creating a memory barrier at this point to ensure that the method checks to see if the lock is free before accessing the piece of shared data, additional operation steps are used to create artificial dependencies between the steps of the present method to take advantage of ordering guarantees of a processor executing the method. By creating these artificial dependencies the processor will implement the steps of the method in order.

Step 220 is an additional instruction that creates an artificial dependency between subsequent step 225, where the piece of shared data is accessed, and preceding steps 205 and 210, where the value of the lock field was loaded into the first register and this value evaluated to determine if the lock was free. Step 220 is not needed to alter any data or modify any values in the method, but by creating an artificial dependency at step 220, the processor, using the rules of dependency between the first and second registers, causes steps 205 and 210, which use the first register, to be performed before step 220, which involves the second register and third register. Without creating these artificial dependencies at step 220 the processor would not see any connection between the use of the first register in steps 205 and 210 and the second register in step 225 because there is no apparent dependency between the first register and second register. Therefore the processor might perform the step 225 and access the piece of shared data before steps 205 or 210, with the result that the piece of shared data might be accessed by the thread before it is determined that the lock is free. By including this intermediate step where an artificial dependency is created between the first register and the second register, even though this step is not necessary to alter the values stored In the first register and second register, the processor executing the instructions will perform the instructions in a required order so that step 225 is subsequent to steps 205 and 210.

Although a number of different operations can be performed at step 220 to create an artificial dependency between steps 220 and 205, in one embodiment, if a zero (0) value of the lock word is used to indicate that the lock is free, a logical OR operation can be used to create the artificial dependency between steps 205, 210 and 225. By logically ORing the value stored in the first register (which in that case would be zero) with the value stored in the second register (which would indicate the location of the piece of shared data) and storing the result back into the second register, the value stored in the second register is unaltered.

At step 225 the piece of shared data is accessed. The piece of shared data is loaded into the third register from the address where it is located. Because the second register was artificially depended from the first register at step 220, the processor uses its dependency guarantee rules to ensure that step 225 is performed after steps 205 and 210, thereby preventing the piece of shared data being accessed by the method before it is determined whether or not the lock is free.

Alternatively, in some situations, rather than incorporating step 220 so that step 225 has an artificial dependency on steps 205 and 210, it may be possible for step 225 to incorporate the first register in its implementation so that step 225 has a created artificial dependency on steps 205 and 210, without requiring the additional instruction at step 220 to create this dependency. For example, if the value being loaded into the first register is a zero value, step 225 could be altered so that the first register holding this zero value is used in the accessing of the piece of shared data. Rather than using a zero (0) value to access the piece of shared data, the first register could be used in place of the zero (0) value to create an artificial dependency (i.e. rather than implementing step 225 in PowerPC as “1wz r31, 0(r8)”, step 225 could be altered as follows: “1wzx r31, r8. r5”, where r31 holds the value of the shared value, r8 indicates the location in memory of the piece of shared data, and r5 holds the lock word which in this case would be a zero value). In this manner, it is possible in some situations for step 225 to be implemented with an artificial dependency created on steps 205 and 210 without requiring the additional instruction at step 220.

Step 230 is another additional instruction that creates an artificial dependency between steps in the method. Step 230 creates a dependency between subsequent step 235 and preceding step 225. The result of the load at step 225 is dependent on the first register so that the conditional store of step 235 is not performed by the processor until after the piece of shared data is accessed at step 225.

In one embodiment a logical exclusive OR instruction is used to exclusively OR the value of the third register together with itself and save the result in first register where the value of the lock is stored. Because it was determined at the preceding step 210 that the value of the lock field is zero (0), the results of the same value exclusively OR'd with itself will be zero (0) which is already the value of the lock word stored in the first register so all of the values stored in the registers are unaltered by step 230.

At step 235 a conditional store is used to store a value back into the lock word stored in the memory. If a value of zero (0) in the lock word is used to indicate the lock is free, a zero (0) value is written back into the lock word stored in the memory. Step 235 works in conjunction with step 205. At step 235, before a value is stored back into the lock word in memory, the reserve placed on the memory at step 205 is checked to see if the reserve is still set. If the reserve is still present, this indicates that the lock word in the memory has not been accessed by another thread and the store will be completed and the method ends. However, if the reserve has been removed (i.e. another thread has accessed the lock word in the memory while the present method was being performed) the store at step 235 fails and the method loops back to step 205 and begins again. By using the corresponding instructions of a load and reserve at step 205 and a conditional store instruction at step 235 it can be guaranteed that the piece of shared data has not been altered by another thread while the present thread was accessing the shared data.

An example of assembler code of a sample PowerPC instruction sequence for the method illustrated in FIG. 3 is set out in the example below.

| Assembler code | Comments |
|---|---|
| loop: | |
| lwarx r5,0,r3 | load and reserve (read part of atomic |
| | update) |
| cmpwi r5,0 | Test for a free flat lock |
| bne outofline_read | out-of-line code handles special cases and |
| | does the needed read(s) |
| or r8,r8,r5 | r8 now has an artificial dependency on r5; |
| | r5 equals 0 so r8 is unchanged |
| lwz r31,104(r8) | lock protects just this shared data load, use |
| | of r8 forces ordering of lwarx and load |
| xor r5,r31,r31 | r5 has an artificial dependency on r31; r5 |
| | equals 0 |
| stwcx. r5,0,r3 | store conditional (write part of atomic |
| | update); use of r5 forces ordering of load |
| | and stwcx; stores 0 to keep lock free |
| bne- loop | try again if conditional write failed |
| outofline_read_return: | |

Some programming languages, such as Java, require a monitor exit to ensure that all stores to shared data before the monitor enter be visible to other threads before the lock is freed. A StoreExit barrier is required even for a read-only lock sequence. In circumstances where a StoreExit barrier is required, the method illustrated by the flowchart in FIG. 3 can be modified to include the needed StoreExit barrier. The StoreExit barrier can be inserted in a number of places. A StoreExit barrier could be incorporated before the method illustrated in FIG. 3 or alternatively step 230 could be replaced with a StoreExit barrier instruction. The StoreExit barrier will impose some overhead; however, the method illustrated in FIG. 3 will still require fewer synchronization instructions than a conventional lock implementation.

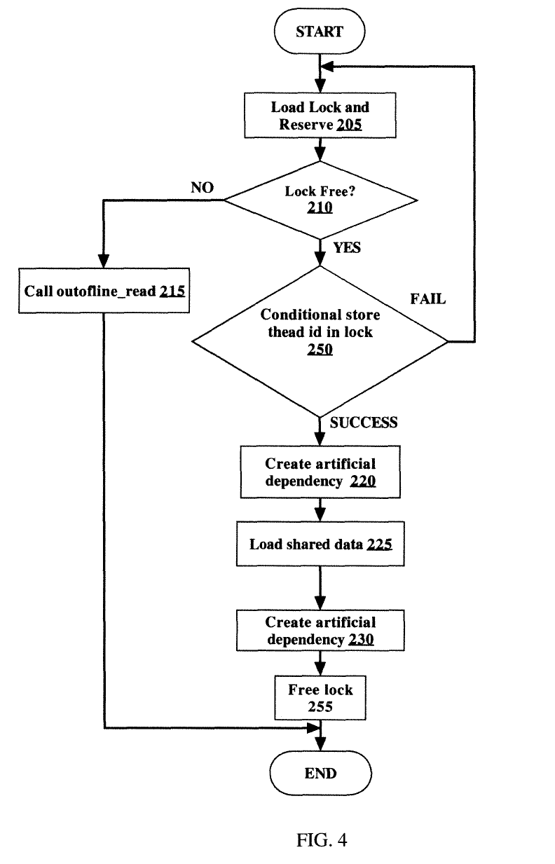

While the flowchart in FIG. 3 provides a first embodiment of a method in accordance with the present invention that does not acquire the lock, in some cases it may desirable for the method to acquire the lock. FIG. 4 illustrates a flowchart of a second embodiment of a method that is an implementation of a read-only lock to grant a thread access to a piece of shared data in accordance with the present invention. The illustrated method is similar to the method illustrated by the flowchart in FIG. 3 with the exception that the present method writes a value to a lock word stored in a memory to acquire the lock.

Steps 205, 210, 215, 220, 225 and 230 are the same steps as the steps of the method illustrated in FIG. 3

Step 250 has been inserted and is a conditional store command that stores a value to a location in memory that contains the lock word so that the thread acquires the lock. The conditional store command at step 250 works in conjunction with the load and reserve command at step 205 to ensure that another thread did not acquire the lock before the present thread has acquired the lock by writing to the location in memory where the lock word is stored. If at step 250 the reserve has been removed., the lock word has been updated and the store will fail causing the method to loop back to step 205 to attempt to acquire the lock again.

Because the present method acquires the lock at step 250 with a conditional store, step 255 also differs from step 235 of the method illustrated by the flowchart in FIG. 3. Because a store conditional instruction occurs at step 250, corresponding to the load and reserve instruction at step 205, step 255 cannot also contain a conditional store command. Step 255 is a standard store command that frees the lock by writing a new value to the location in the memory where the lock word is stored. If a zero (0) value is used to indicate a tree lock, a zero (0) value is stored to the memory where the lock word is stored.

Again, artificial dependencies between the steps of the method are created with additional instructions at steps 220 and 230 to ensure a processor performs the instructions in the method in a required order. Step 220 creates an artificial dependency between previous steps 205, 210 and 250 and the later subsequent step 225, causing a processor to perform these steps in a required order. Step 230 creates an artificial dependency between previous step 225, where the piece of shared data is accessed and step 255, where the lock is freed, causing a processor to perform the steps in this order and preventing the lock being freed before the piece of shared data has been accessed by the method.

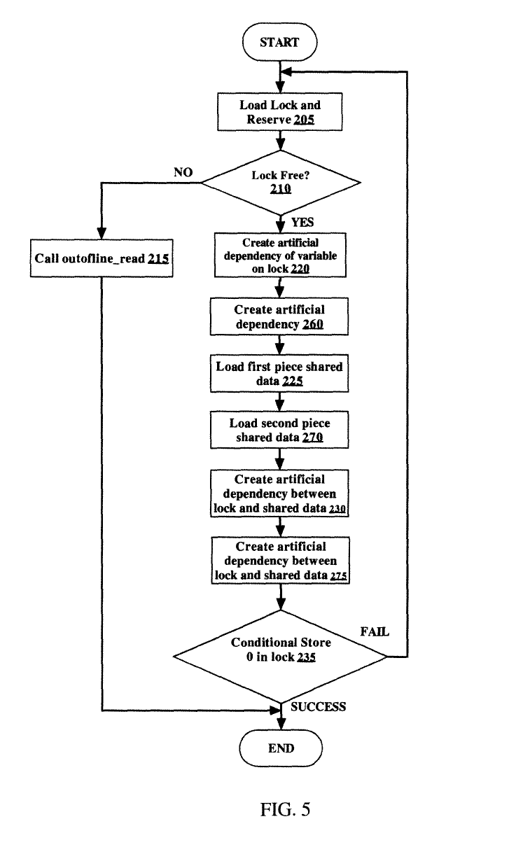

FIG. 5 illustrates a flowchart of a third embodiment of a method in accordance with the present invention that is an implementation of a read-only lock protecting multiple pieces of shared data. This method illustrates how more than one piece of shared data can be protected by a read-only lock in accordance with a third embodiment of the present invention.

The method illustrated in FIG. 5 is similar to the method illustrated by the flowchart in FIG. 3 with the exception that rather than the lock allowing access to only a first piece of shared data at step 225, the lock also allows access to a second piece of shared data at step 270. Because the second piece of shared data will be stored in a location of memory different from the lock itself and the first piece of shared data, artificial dependencies must be created by the method so that a processor executing the method will perform the steps in a required order with step 270 subsequent to steps 205 and 210 and preceding step 235. Additional instructions at step 260 are also performed to create an artificial dependency between step 270 and steps 205 and 210 and another additional instruction is performed at step 275 to create an artificial dependency between step 270 and step 235.

By ensuring that artificial dependencies are created between the load operations, where the pieces of shared data are accessed, and the load and reserve command at step 205, where the lock word is obtained, and another set of artificial dependencies are created between the load operations, where the pieces of shared data are accessed, and the conditional store instruction at step 235, a required order of execution of the steps in the method is ensured and any practical number of pieces of shared data can be protected by the lock using the illustrated method. A computer program may access one or more of the pieces of shared data protected by a particular lock word when using a read-only lock according to an aspect of the present invention. What is important is that none of the pieces of data protected by a particular lock is accessed unless the lock is free.

In one embodiment of the present invention the improved read-only flat lock implementations are accomplished in a program using a compiler optimization technique (e.g. a lava Just-in-Time (JIT) compiler). The methods illustrated in FIGS. 3, 4 and 5 are implemented in a low-level code, specifically assembly language that can be interpreted by a specific computer architecture to implement the instruction steps of the low-level code. In typical programming languages, such as Java, implementing such low-level logic can often be done but it requires careful analysis of the acts and coding in order to implement; often requiring implementing assembler code within the higher-level program code itself in order to implement the desired logic. However, the majority of programming is done in a programming language of higher-level code, such as Java, with a compiler using the higher-level program code (or source code) to generate a corresponding low-level code (or output code). Rather than using the specific instructions as outlined in FIGS. 3, 4 and 5 to implement a lock sequence in a higher-level program code, a programmer typically writes program code in a higher-level code that calls for a lock and the compiler analyzes the source code and generates a corresponding low-level code. The corresponding low-level code generated by the compiler would provide the instructions as shown in FIGS. 3, 4 or 5. In this manner, the present invention can be implemented without requiring a programmer to implement Individually engineered logic and low-level code to convert, each lock that is a read-only lock into an improved read-only lock implementation in accordance with the present invention.

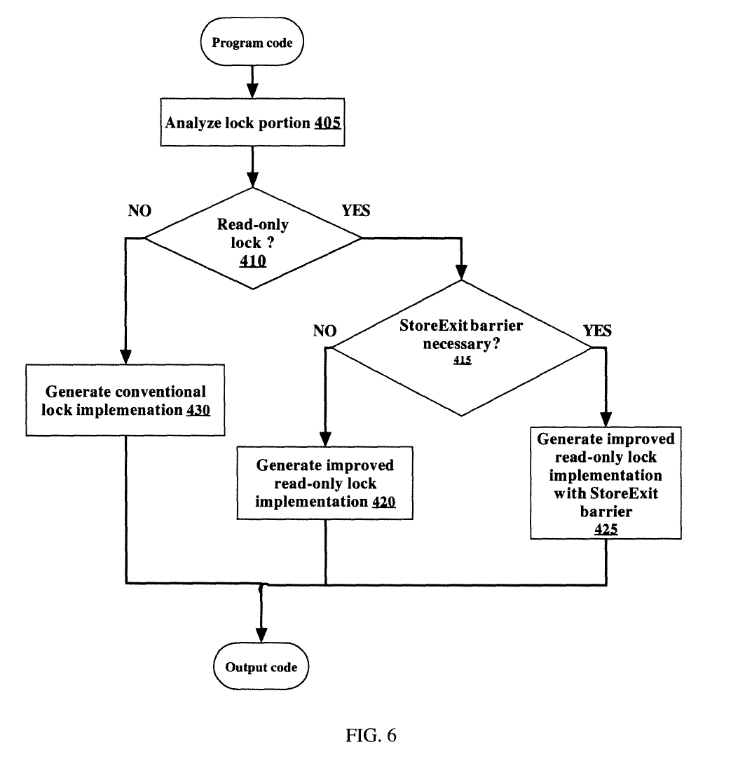

FIG. 6 illustrates a flowchart of a method of improving a read-only lock portion of a program code using an improved read-only lock implementation, such as the implementations illustrated in FIGS. 3, 4 or 5, in accordance with the present invention. The method comprises the steps of: analyzing a lock portion of a program code 405; determining if the lock portion is a read only lock 410; generating a conventional lock implementation 430 if the lock is not a read-only lock; determining whether a StoreExit barrier is necessary if the lock is a read-only lock 415; generating an improved read-only lock implementation 420 if the lock is a read-only lock and a StoreExit barrier is not required; and generating an improved read-only lock implementation with a StoreExit barrier 425 if the lock is a read-only lock and a StoreExit barrier is necessary or it cannot be determined that a StoreExit barrier is not necessary.

The method begins by analyzing a lock portion of a program code at step 405. The method is executed by a compiler at compile time with the program code being a particular target program code, such as source code of high-level code that the compiler is converting into a low-level code implementation as the output code with the output code corresponding to the source code. Alternatively, the compiler could be compiling a Java application as it executes and the target program code could be the Java bytecode from the Java application.

Step 410 identifies whether the lock portion of the program code is a read-only lock. For the lock portion of the program code to be a read-only lock a number of criteria must be met, such as: the synchronized region of code does not contain any writes to global data structures or global variables; the synchronized region of code does not contain other locks nested inside; the synchronized region of code does not contain exception points; and finally the synchronized region of code must be restricted to be read-only on all control flow paths in the code.

In response to determining at step 410 that the lock portion of the program code is not a read-only lock, a conventional lock implementation is generated at step 430 and used to implement the called for lock sequence. This conventional lock implementation could be similar to the implementation illustrated in FIG. 2 or some other implementation.

In response to determining at step 410 that the lock portion of the program code is a read-only lock, if the program language has specific requirements for the use of monitor exit, such as the Java language that requires a monitor exit to ensure that all stores to shared data before the monitor enter be visible to other threads before the lock is freed, the method analyzes the program code leading up to the lock portion at step 415 and if it can be determined that there are no writes to shared data since the last StoreExit barrier (such as a monitor exit or volatile store), then the compiler can mark this read-only lock sequence as not requiring a StoreExit barrier.

If a StoreExit barrier is not required, an improved low-level code lock sequence, such as an improved low-level lock implementation as shown in FIGS. 3. 4 or 5 is generated at step 420 and used to implement the called-for lock in the program code.

However, if it is determined that a StoreExit is needed or that it cannot be determined whether or not a StoreExit is needed, an improved low-level code lock implementation, such as the implementation shown in FIGS. 3, 4 or 5 is generated at step 425 with a StoreExit instruction included

Once the code has been generated either at step 430, 420 or 425, the method ends.

The foregoing is considered as illustrative only of the principles of the invention. Further, since numerous changes and modifications will readily occur to those skilled in the art, it is not desired to limit the invention to the exact construction and operation shown and described, and accordingly, ail such suitable changes or modifications in structure or operation which may be resorted to are intended to fall within the scope of the claimed invention.

What is claimed is:

1. A computer-implementable method of generating a read-only lock implementation from a read-only lock portion of a program code, comprising:
in response to determining that a lock portion of the program code is a read-only lock, generating a read-only lock implementation to protect at least one piece of shared data wherein the read-only lock implementation comprises a plurality of instructions with dependencies created between the instructions to ensure that a lock corresponding to the at least one piece of shared data is determined to be free before permitting access to the at least one piece of shared data,

2. The method of claim 1 wherein the read-only lock implementation, when executed by a data processing system, causes the data processing system to perform the following steps:
loading a lock word from a memory address into a register and placing a reserve on the memory address;
responsive to loading the lock word, evaluating the lock word to determine if the lock is free;
responsive to determining that the lock is free, accessing one or more of the at least one piece of shared data; and
conditionally storing a value back to the memory address if the reserve is present,
wherein a dependency exists between the step of loading of the lock word and the step of accessing the one or more of the at least one piece of shared data, thereby causing the data processing system to perform the loading of the lock word before the data processing system performs the accessing of the one or more of the at least one piece of shared data.

3. The method of claim 2 wherein the method uses at least one additional instruction to create the dependency between the step of loading of the lock word and the step of accessing the one or more of the at least one piece of shared data.

4. The method of claim 3 wherein the at least one additional instruction performs an operation on values that leaves the values unaltered.

5. The method of claim 1 wherein the method is carried out when the program code is compiled.

6. The method of claim 1 wherein the program code is Java bytecode

7. A computer-implementable method of performing a read-only lock on at least one piece of shared data, the method comprising:
loading a lock word from a memory address into a register and placing a reserve on the memory address;
responsive to loading the lock word, evaluating the lock word to determine if the lock is free;
responsive to determining that the lock is free, accessing at least one piece of shared data protected by the lock; and
conditionally storing a value back to the memory address if the reserve is present,
wherein dependencies created between the steps cause the step of evaluating the lock word to determine if the lock is free to be performed prior to accessing the at least one piece of shared data.

8. The method of claim 7 wherein at least one dependency is created between steps by an additional instruction.

9. A multi-threaded data processing system for generating a read-only lock implementation from a read-only lock portion of a program code, comprising:
at least one processor;
a memory operatively coupled to the at least one processor; and
a program module stored in the memory operative for providing instructions to the at least one processor, the at least one processor responsive to the instructions from the program module to cause the data processing system to:
in response to determining that a lock portion of a program code is a read-only lock, generate a read-only lock implementation to protect at least one piece of shared data wherein the read-only lock implementation comprises a plurality of instructions with dependencies created between the instructions to ensure that a lock corresponding to the at least one piece of shared data is determined to be free before permitting access to the at least one piece of shared data.

10. The data processing system of claim 9 wherein the read-only lock implementation, when executed by the data processing system, causes the data processing system to execute the following steps:
loading a lock word from a memory address into a register and placing a reserve on the memory address;
responsive to loading the lock word, evaluating the lock word to determine if the lock is free;
responsive to determining that the lock is free, accessing one or more of the at least one piece of shared data; and
conditionally storing a value back to the memory address if the reserve is present,
wherein a dependency exists between the step of loading of the lock word and the step of accessing the one or more of the at least one piece of shared data, thereby causing the data processing system to perform the loading of the lock word before the data processing system performs the accessing of the one or more of the at least one piece of shared data.

11. The data processing system of claim 10 wherein the method uses at least one additional instruction to create the dependency between the step of loading of the lock word and the step of accessing the one or more of the at least one piece of shared data.

12. The data processing system of claim 11 wherein the at least one additional instruction performs an operation on values that leaves the values unaltered.

13. The data processing system of claim 9 wherein the steps are executed when the program code is compiled.

14. The data processing system of claim 9 wherein the program code is Java bytecode.

15. A computer program product comprising a computer useable medium including a computer-readable program for generating a read-only lock implementation from a read-only lock portion of a target program code, wherein the computer-readable program comprises.
computer-readable program code for generating, in response to determining that a lock portion of the target program code is a read-only lock, a read-only lock implementation to protect at least one piece of shared data wherein the read-only lock implementation comprises a plurality of instructions with dependencies created between the instructions to ensure that a lock corresponding to the at least one piece of shared data is free before permitting access to the at least one piece of shared data.

16. The computer program product of claim 15 wherein the read-only lock implementation generated by the computer program product, when executed by a data processing system, causes the data processing system to execute the following steps:
loading a lock word from a memory address into a register and placing a reserve on the memory address;
responsive to loading the lock word, evaluating the lock word to determine if the lock is free;
responsive to determining that the lock is free, accessing one or more of the at least one piece of shared data; and
conditionally storing a value back to the memory address if the reserve is present,
wherein a dependency exists between the step of loading of the lock word and the step of accessing the one or more of the at least one piece of shared data, thereby causing the data processing system to perform the loading of the lock word before the data processing system performs the accessing of the one or more of the at least one piece of shared data,

17. The computer program product of claim 16 wherein the method uses at least one additional instruction to create the dependency between the step of loading of the lock word and the step of accessing the one or more of the at least one piece of shared data.

18. The computer program product of claim 17 wherein the at least one additional instruction performs an operation on values that leaves the values unaltered.

19. The computer program product of claim 15 wherein the method is carried out when the program code is compiled.

20. The computer program product of claim 15 wherein the program code is Java bytecode.
